(19) United States
(12) Patent Application Publication
(10) Pub. No.: US 2004/0245313 A1
(43) Pub. Date: Dec. 9, 2004

(54) Pea shooter tool

(76) Inventor: Thomas T. Hall JR., Childs, MD (US)

Correspondence Address: Theresa M. Seal, Esq., 2391 Ridge Road Extension, Ambridge, PA, 15003, US

(21) Appl. No.: 10/452,087

(22) Filed: Jun. 3, 2003

(51) Int. Cl. B25C 7/00

(52) U.S. Cl. 227/147

(57) ABSTRACT

A manually operable device for aligning and driving fasteners into material includes a barrel having a bore into which fasteners can be placed or dropped and the barrel capable of reaching difficult, narrow, tight spaces that are unreachable by a hammer. Disposed within the bore is a drive rod having a flat face for contacting and striking the fastener. A handle is connected to the drive rod and is manually reciprocated by the individual thereby transmitting reciprocable motion to the drive rod so that the drive rod can strike and drive the fastener into the material. When in operation the handle, the drive rod, and the nail are disposed in axial alignment thus maximizing the striking force of the drive rod against the fastener and enhancing the efficient use of the device.

### FIELD OF THE INVENTION

The present invention pertains to pneumatic, hydraulic and manually operable devices for driving fasteners, such as nails, into material substrates like wood, plastic, metal or concrete, and more particularly pertains to a hand operable nail driving device that maintains the position and alignment of the nails for driving the nails into tight, narrow spaces that are generally unreachable with conventional hammers.

### SUMMARY OF THE INVENTION

The use of nails and other types of fasteners to secure and fix in place structural elements such as wooden beams, paneling, roof shingles and concrete framework is ubiquitous in both the private and commercial building and construction fields. Driving nails and other types of fasteners into material substrates is relatively easy when the area is flat, open and unobstructed such as an expanse of roof or the side wall of a large commercial building.

However, there are countless instances where nails and other types of fasteners must be infixed in locations and spaces that are tight, narrow, awkward to reach or obstructed by, for example, plumbing conduit, electrical lines, engines, compressors, hvac equipment and lines and the like. In such cases a conventional hammer is of no use because the narrow, constricted area inhibits or completely prevents the individual from utilizing the full arcuate swinging or striking motion of the hammer to drive in the nail. Even if the individual is able to employ a reduced striking motion, the force produced by such an attenuated hammer stroke may be wholly ineffectual for driving in the nail.

In view of the above difficulties of driving nails in tight, narrow spaces, and the attendant difficulty of aligning and maintaining the nail in the appropriate position prior to infixing the nail in the substrate, a number of devices have been conceived to facilitate the process of nail emplacement.

For example, Elmore et al. (U.S. Pat. No. 4,201,258) discloses a nail holder having pivotable jaws capable of holding a nail in an opening formed by the closure of the jaws. The distal ends of the jaws include grooves for holding small diameter fasteners and at least one jaw has measuring indicia marked thereon.

The Rix patent (U.S. Pat. No. 4,221,248) discloses a nail holder for fastening nails into corrugated roofing and includes a pair of pivotable jaws for gripping the nail and structure adapted to receive a portion of the roofing whereupon a hammer can be used to strike the nail and drive the nail into the roofing.

The Brosius patent (U.S. Pat. No. 4,252,259) discloses a low velocity impact or hammer drive tool for driving in fasteners, and employs a firing pin assembly and powder charge to actuate an anvil-type structure for striking and driving in fasteners.

The Thurner device (U.S. Pat. No. 4,802,802) discloses an integral flange and sleeve structure fitted to a nail and which is passed through an opening so that striking the nail causes the sleeve to squash or flatten about the opening thereby securing the integral flange and sleeve structure, and the nail, in position.

The Aske et al. device (U.S. Pat. No. 5,038,665) discloses a propellant operated, single shot stud gun for driving fasteners into bridges and building structures.

While the above devices display a range of ingenuity they are not adaptable or usable for driving nails in tight, narrow, hard to reach spaces and locations. Therefore, there is a need for a simple, manually operable nail driving device that can be easily and quickly maneuvered into tight, narrow spaces for aligning and driving nails thereinto.

### BACKGROUND OF THE INVENTION

The present invention comprehends a manually operable device for driving in fasteners in tight, difficult to reach locations that are unreachable by a hammer.

The manually operable device includes a cylindrical, elongated barrel having an inner end and an opposite surface contact end. A bore extends through the barrel from the inner end to the surface contact end. Disposed within the barrel is an elongated drive rod. The drive rod has an attachment end and an opposite working or fastener contact end, and the drive rod is capable of linear reciprocable movement within the barrel so that the fastener contact end can successively strike the fastener for infixing the fastener to and in the material. Connected to the attachment end of the drive rod, and extending externally from the barrel, is a handle that is grasped by the individual for back and forth motion. The handle is connected in axial alignment with the drive rod so that the line of motion of the handle is concomitant with the reciprocable movement of the drive rod.

It is an objective of the present invention to provide a manually operable device for driving in fasteners that is lightweight, portable and easy to operate.

It is another objective of the present invention to provide a manually operable device for driving in fasteners that is highly maneuverable in order to reach narrow, tight locations.

Yet another objective of the present invention is to provide a manually operable device capable of driving in fasteners of various sizes and configurations.

Still another objective of the present invention is to provide a manually operable device capable of driving 4, 6, 8, 10 and 16 penny nails into various kinds of material including wood, metal, plastic, steel and concrete.

Still yet another objective of the present invention is to provide a manually operable device capable of providing sufficient driving force for infixing nails into concrete framework.

These and other objects, features and advantages will become apparent to those skilled in the art upon a perusal of the following detailed description and the accompanying drawings.

### BRIEF DESCRIPTION OF THE DRAWINGS

FIG. 1 is an exploded isometric view of the manually operable nail driver of the present invention;

FIG. 2 is a side elevational view of the manually operable nail driver illustrating the disposition of the fastener and the drive rod prior to the fastener being infixed into the material by the action of the drive rod;

FIG. 3 is a side elevational view of the manually operable nail driver illustrating the drive rod striking the fastener for infixing the fastener into the material; and

FIG. 4 is a front elevational view of the manually operable nail driver illustrating an alternative design for the handle that is shown in FIGS. 1-3.

### DETAILED DESCRIPTION OF THE PREFERRED EMBODIMENT

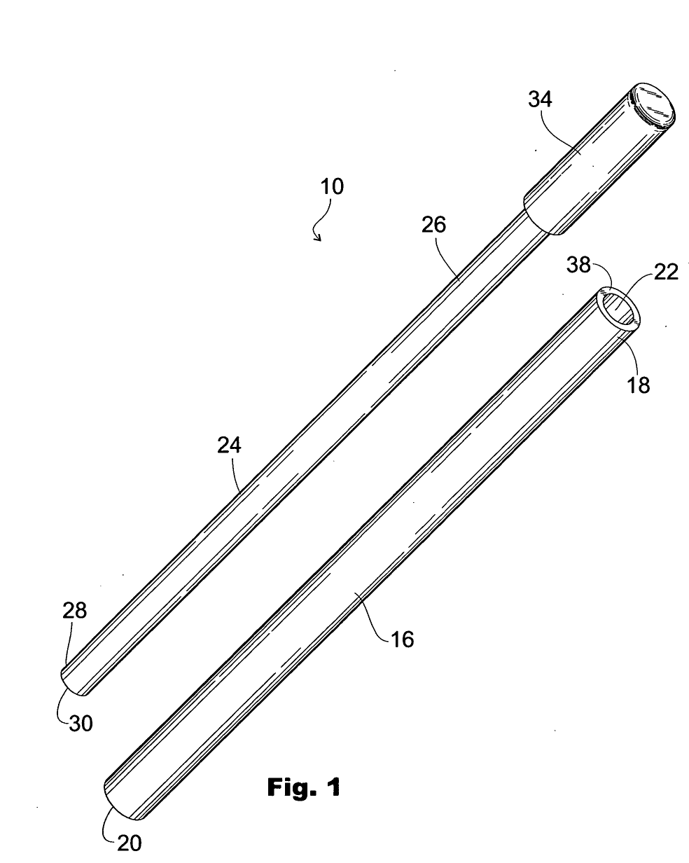

Illustrated in FIGS. 1-4 is a manually operable device 10 for driving fasteners, such as nails 12, into material 14 such as wood, metal, plastic or concrete framework. The device 10 of the present invention is slender, lightweight, rugged and highly maneuverable for reaching awkward and difficult locations and for use in narrow, tight spaces that are unreachable by a hammer or that prevent the individual from achieving an adequate range of striking motion for the hammer.

As shown in FIGS. 1-4, the manually operable device 10 includes a slender, cylindrical, elongated barrel 16 that has an inner end 18 and an opposite surface contact or engagement end 20. The surface contact end 20 of the barrel 16 is flat so that the surface contact end 20 can be placed contiguous to the material 14 in which the nail 12 is to be driven. The barrel 16 also includes a cylindrical bore 22 that extends from the inner end 18 to the surface contact end 20. The barrel 16 is preferably composed of a heavy walled galvanized pipe.

The manually operable device 10 includes a drive rod 24, as illustrated in FIGS. 1-4, that is the moving and working element for successively striking the nail 12 in order to infix the nail 12 into the material 14. The drive rod 24 is elongated and cylindrical-shaped for disposition within the bore 22 and is manually actuated by the individual for slidable, reciprocable movement therein. The drive rod 24 of the present invention is generally coequal in length with the barrel 16 and is axially aligned with the barrel 16. The drive rod 24 includes a handle connection end 26 and an opposite interior working end 28, and the drive rod 24 is preferably a round steel rod. The interior working end 28 has a flat face 30 for contacting the nail head 32 and driving the nail 12 into the material 14.

As shown in FIG. 1-3, the device 10 includes a cylindrical handle 34 that is attached to the handle connection end 26; and, more specifically, the handle 34 includes a tapped and threaded blind hole 36 that facilitates securement of the handle 34 to the handle connection end 26 of the drive rod 24. The handle 34 and the drive rod 24 can be integrally formed or joined as one unit in an alternative structure. When the device 10 is fully assembled, the handle 34 and the drive rod 24 are disposed in axial alignment with the barrel 16. The handle 34 of FIGS. 1-3 has the same outside diameter as the barrel 16 and includes an annular abutment surface 38 can impinge the inner end 18 of the barrel 16 during the back and forth movement of the handle 34 thereby delimiting the travel of the handle 34 and preventing the handle 34 from physically entering the bore 22. The handle 34 is also preferably manufactured from a durable steel material.

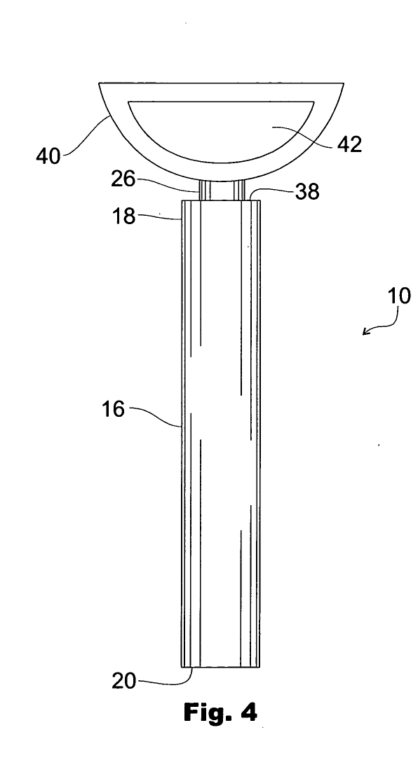

FIG. 4 illustrates an alternative embodiment for the handle 34 that is a triangular-shaped handle 40 similar to the handle of the saw. The handle 40 of FIG. 4 includes an aperture or hand opening 42 through which the individual can insert his hand for gripping the handle 40. The handle 40 of the device 10 could, in fact, include a range of geometric shapes such as a circle or parallelogram to enhance the ease with which the handle 34 or 40 can be gripped and held. The handle 40 of FIG. 4 may be more ergonomically designed than the handle 34 of FIGS. 1-3 for maximizing the striking force of the drive rod 24. Thus, the motion of the individual's arm would be closer or coincident to the line of action of the drive rod 24 when reciprocating the handle 40 of FIG. 4; whereas the motion of the individual's arm would be slightly at angle to the line of action of the drive rod 24 when reciprocating the handle 34 of FIGS. 1-3.

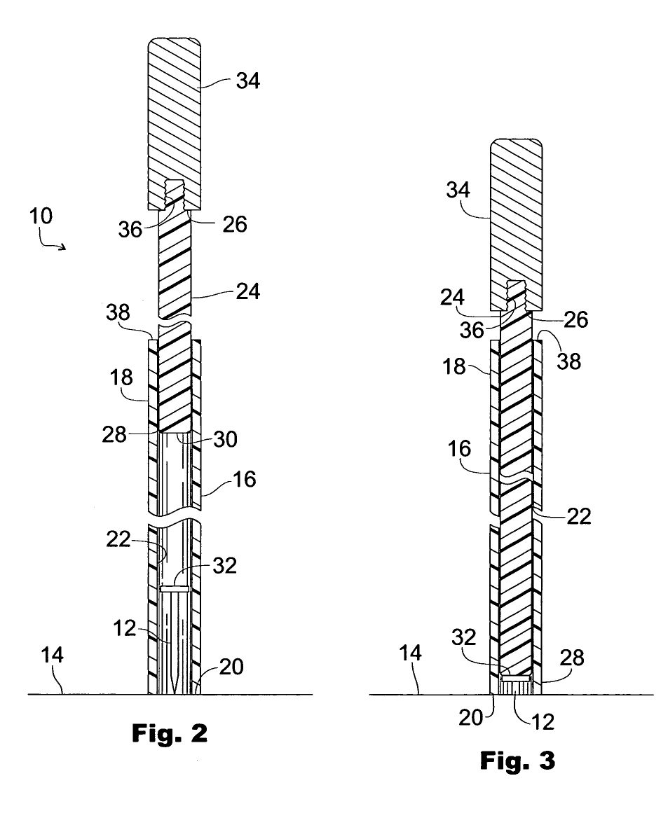

With reference to FIGS. 2 and 3, in using the device 10 the individual could first set the nail 12 in position if the location were an overhead location. Alternatively, with the drive rod removed 24, the barrel 16 could be placed on the location and directly against the material 14 the nail 12 is to be driven into and then the nail 12 would be dropped into the barrel 16. Dropping the nail 12 down into the bore 22 of the barrel 16—whereupon the nail 12 rests upon the material 14—serves to both align and further maintain the nail 12 in the appropriate position to facilitate its emplacement into the material 14. The drive rod 24 would then be slipped into the barrel 16 at the inner end 18. The individual would then grasp the handle 34 or 40 and move the handle 34 or 40 back and forth thereby transmitting linear motion to the drive rod 24 and causing the face 30 at the interior working end 28 of the drive rod 24 to repeatedly strike the nail 12 until the nail 12 is driven into the material 14 to the sufficient depth. The individual may need to strike the nail 12 only once or numerous times to drive and secure the nail 12 into the material 14. Upon securely driving the nail 12 into the material 14, the barrel 16 can be simply removed or lifted from its engagement against the material 14 so that the individual can move to the next location or set aside and store the device 10 for further or future use.

The foregoing description discloses and describes a preferred embodiment for the invention, and those skilled in the art will understand that other variations and modifications may be possible and practicable, and still come within the ambit of the invention.

I claim:

1. A manually operable device for driving in nails, comprising:
an elongated barrel having an inner end and an opposite surface contact end, and a bore extending from the inner end to the surface contact end;
an elongated drive rod disposed within the barrel and capable of linear reciprocable movement within the bore;
the drive rod having an interior working end for striking the nail so that the nail can be driven into the material; and
a hand graspable handle attached to the drive rod and external to the barrel whereupon reciprocable back and forth motion on the handle is transmitted to the drive rod for reciprocating the drive rod and driving the nail into the material.

2. The device for driving in nails of claim 1 wherein the handle is triangular-shaped and defines an opening so that the hand of an individual can be inserted therethrough for grasping and holding the handle while driving in the nail.

3. The device for driving in nails of claim 2 wherein the handle is parallelogram-shaped and defines an opening so that the hand of an individual can be inserted therethrough for grasping and holding the handle while driving in the nail.

4. The device for driving in nails of claim 3 wherein the handle is cylindrical-shaped and in axial alignment with the drive rod and is graspable by the individual for driving in the nail.

5. Apparatus for driving fasteners into material, comprising:
an elongated barrel having an inner end and an opposite surface contact end, and a bore extending through the barrel from the inner end to the surface contact end;
an elongated drive rod disposed within the barrel for linear reciprocable movement therein in order to successively strike the fasteners and drive the fasteners into the material;
the drive rod having an inner driving end for striking the fasteners and driving the fasteners into the material; and
a cylindrical-shaped handle connected to the drive rod and projecting externally to the barrel whereupon manually actuated reciprocable motion of the handle is communicated to the drive rod causing the drive rod to successively strike the fasteners and drive the fasteners into the material.

6. A hand operable device for driving fasteners into material, comprising:
an elongated barrel having an inner end and an opposite surface contacting end, and a bore extending therethrough;
an elongated drive rod disposed within the bore in axial alignment therewith for linear, reciprocable movement therein for driving fasteners into material; and
a handle connected to the drive rod and having an opening through which the hand of the individual can be inserted for grasping and reciprocating the handle thereby transmitting reciprocable motion to the drive rod causing the drive rod to successively strike the fasteners resulting in the fasteners being driven into the material.

7. A manually operable device for driving a nail into a substrate material, comprising:
an elongated barrel having an inner end, an opposite surface engagement end, and a bore extending therethrough from the inner end to the surface engagement end;
an elongated drive rod for disposition within the bore and in axial alignment therewith for linear reciprocable movement therein for striking the nail and driving the nail into the material substrate;
a handle connected to the drive rod and extending externally from the handle opposite the surface engagement end so that the handle can be manually reciprocated for transmitting reciprocable motion to the drive rod and causing the drive rod to slide within the bore striking the nail and driving the nail into the substrate material; and
the barrel capable of receiving the nail within the bore for maintaining the alignment of the nail in the predetermined position while the nail is being struck and driven into the material substrate by the drive rod.
